(19) United States
(12) Patent Application Publication
(10) Pub. No.: US 2007/0269219 A1
(43) Pub. Date: Nov. 22, 2007

(54) SYSTEM AND APPARATUS FOR OPTICAL COMMUNICATIONS THROUGH A SEMI-OPAQUE MATERIAL

(76) Inventors: Witold R. Teller, Pullman, WA (US); Luther S. Anderson, Pullman, WA (US); Steven A. McMahon, Clarkston, WA (US); James R. Kesler, Pullman, WA (US); Donald C. Hicks, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/750,917

(22) Filed: May 18, 2007

Related U.S. Application Data
(60) Provisional application No. 60/802,078, filed on May 19, 2006.

(51) Int. Cl. H04B 10/00

(52) U.S. Cl. 398/140

(57) ABSTRACT

A light based communication system is provided including at least one phototransmitter which generates an optical signal which is detected by at least one photodetector that is encapsulated in potting material. The phototransmitter is optically coupled to the photodetector through the potting material. The photodetector transforms the optical signal into an electrical signal usable by electronic devices connected to the photodetector.

### CROSS-REFERENCE TO RELATED APPLICATIONS

This application claims benefit under 35 U.S.C. §119(e) of U.S. Provisional Application entitled “SYSTEM AND APPARATUS FOR OPTICAL COMMUNICATIONS THROUGH A SEMI-OPAQUE MATERIAL,” filed on May 19, 2006, having Ser. No. 60/802,078, naming Witold Teller, Donald C. Hicks, Luther S. Anderson, Steven A. McMahon, and James R. Kesler as inventors, the complete disclosure thereof being incorporated by reference.

### FIELD OF THE INVENTION

The present invention relates generally to a systems and apparatus for optical communication, and more particularly to systems and apparatuses for optical communication through a semi-opaque material.

### DESCRIPTION OF THE PRIOR ART

Power transmission and distribution systems may include power system protection, monitoring, and control devices such as protective relays, faulted circuit indicators, and the like. Throughout, the term “power system device” will include any power system protection, monitoring, or control device. Faulted circuit indicators (FCIs) play a vital role in detecting and indicating faults and locations of faulted conductors to decrease the duration of power outages and improve the reliability of power systems throughout the world. Electrical utilities depend on faulted circuit indicators to help their employees quickly locate faulted conductors. Most conventional faulted circuit indicators utilize a mechanical target or a light emitting diode (LED) to provide a visual indication of a faulted conductor. By visually scanning faulted circuit indicators located at a site, an electrical utility crew can quickly locate a fault. Industry statistics indicate that faulted circuit indicators reduce fault location time by 50%-60% versus the use of manual techniques, such as the “refuse and sectionalize” method. Nonetheless, electrical utilities still spend substantial amounts of time and money determining the locations of faults on their networks.

Electrical utilities rely on a number of additional techniques to further decrease time spent locating faults. For instance, modern faulted circuit indicators frequently have one or more contact outputs that activate on the detection of a fault. These contact outputs can be connected to a Supervisory Control and Data Acquisition (“SCADA”) system, allowing remote monitoring of a given faulted circuit indicator's status. This technique works well for above-ground sites, where a cable from the faulted circuit indicator to a monitoring device can be installed, and the monitoring device can be connected to a remote site by a communications line. However, this technique is expensive for underground sites, where an underground communications line must be installed.

Another recent advancement is the use of radio frequency (“RF”) technology within fault circuit indication systems. In one prior art system, each faulted circuit indicator contains a two-way radio that communicates the occurrence of a fault to an intelligent module installed within 100 feet of the faulted circuit indicator. The intelligent module then uses the existing telephone network to communicate a fault occurrence to a remote site, triggering the dispatch of a team to the fault site. However, this system is vulnerable to phone network outages. In addition, a crew dispatched to the fault site must then monitor a readout located on the intelligent module to ensure that the fault has been properly cleared. As the intelligent modules are frequently located on power line poles, viewing an intelligent module's readout may be inconvenient.

An improvement on this system is the use of a wireless device to monitor radio signals from RF equipped faulted circuit indicators. Using a wireless device, a utility crew can quickly locate a fault and determine when the fault has been properly cleared by monitoring the display of the wireless device.

The technology within faulted circuit indicators has also improved. Primitive electromechanical units gave way to more sophisticated analog electronic units, which have given way to microprocessor driven units. Modern units utilize sophisticated algorithms both to detect faults and conserve battery life. However, as more sophisticated microprocessor based algorithms have been introduced, problems with the implementation of the algorithms have escaped detection until deployment in the field. Therefore, various methods of updating deployed units have been used. However, prior art updating methods have usually relied on wired electrical connections. Given that faulted circuit indicators may be deployed underground in extremely damp conditions, the use of a wired electrical connection is expensive, inconvenient, and even impractical. One solution to this is the use of an optical connection.

Accordingly, one object of the invention is to provide an optical interface to a hardened device.

The use of optical technology for data communications is known in the prior art. In particular, the use of phototransmitters, such as light emitting diodes, and photodetectors, such as photodiodes, are in use in both fiber based and free space optical communications systems. Most systems attempt to ensure that the space between the phototransmitter and the photodetector is as close to transparent as possible given the particular radiation used.

Different varieties of potting material are frequently used to environmentally harden electronic equipment. Potting material provides a physical barrier around the electronic components. This barrier is malleable, providing increased resistance to shock and vibration. In addition, if the potting material is properly cured, the barrier will be watertight. Ideally, all electronic components will be completely encapsulated within the watertight potting material.

A number of different types of potting materials are in widespread use. These include epoxy-based materials, urethane based materials, silicone based materials, acrylic based materials, polyester based materials, and others. Urethane and silicone based materials are the types used most often in the electronics industry. Each particular type of potting material has its own strengths and weaknesses.

Therefore, another object of the invention is to provide an optical interface to a hardened device where the electronics of the hardened device are entirely encapsulated in potting material.

### SUMMARY OF THE INVENTION

The present invention achieves its objectives through the use of a light based communication system comprising at least one phototransmitter which generates an optical signal which is detected by at least one photodetector that is optically coupled to the phototransmitter through a material that is at least somewhat opaque to the optical signal. The photodetector then transforms the optical signal into an electrical signal usable by electronic devices connected to the photodetector.

Another embodiment of this invention is similar to the previous embodiment but uses potting material between the lens of the phototransmitter and the lens of the photodetector.

Yet another embodiment of this invention is similar to the previous embodiments except that infrared radiation is used to communicate between the phototransmitter and the photodetector.

In yet another embodiment of this invention, light within the visible spectrum is used to communicate between the phototransmitter and the photodetector.

Still yet another embodiment of this invention is an apparatus for transmitting information to a power system device, such as a faulted circuit indicator, where the power system device includes an optical interface. At least one aperture is formed within the surface of a housing. A circuit board is disposed within the housing, and at least one phototransmitter is placed on the circuit board so that the lens of the phototransmitter is axially aligned with the aperture. Potting material is then disposed within the housing so that the circuit board is substantially covered, including the lens of the phototransmitter.

### BRIEF DESCRIPTION OF THE DRAWINGS

Although the characteristic features of this invention will be particularly pointed out in the claims, the invention itself, and the manner in which it can be made and used, can be better understood by referring to the following description taken in connection with the accompanying drawings forming a part hereof wherein like reference numerals refer to like parts throughout the several views and in which:

FIG. 1 illustrates a system view of a faulted circuit indicator monitoring system in accordance with the present invention;

FIG. 2 illustrates a cutout side view of an embodiment of an interface between an optical communication device and an electronic device in accordance with one aspect of the present invention;

FIG. 3 illustrates a perspective view of a radio interface unit in accordance with one aspect of the present invention;

FIG. 4 illustrates a perspective view of an embodiment of an interface between an optical communication device and the radio interface unit of FIG. 3 in accordance with one aspect of the present invention;

FIG. 5 illustrates a perspective view of a radio interface unit in accordance with one aspect of the present invention; and,

FIG. 6 illustrates a perspective view of an embodiment of an interface between an optical communication device and the radio interface unit of FIG. 5 in accordance with one aspect of the present invention.

FIG. 7 illustrates a perspective view of an optical communication device in accordance with one aspect of the present invention.

### DETAILED DESCRIPTION OF THE ILLUSTRATED EMBODIMENTS

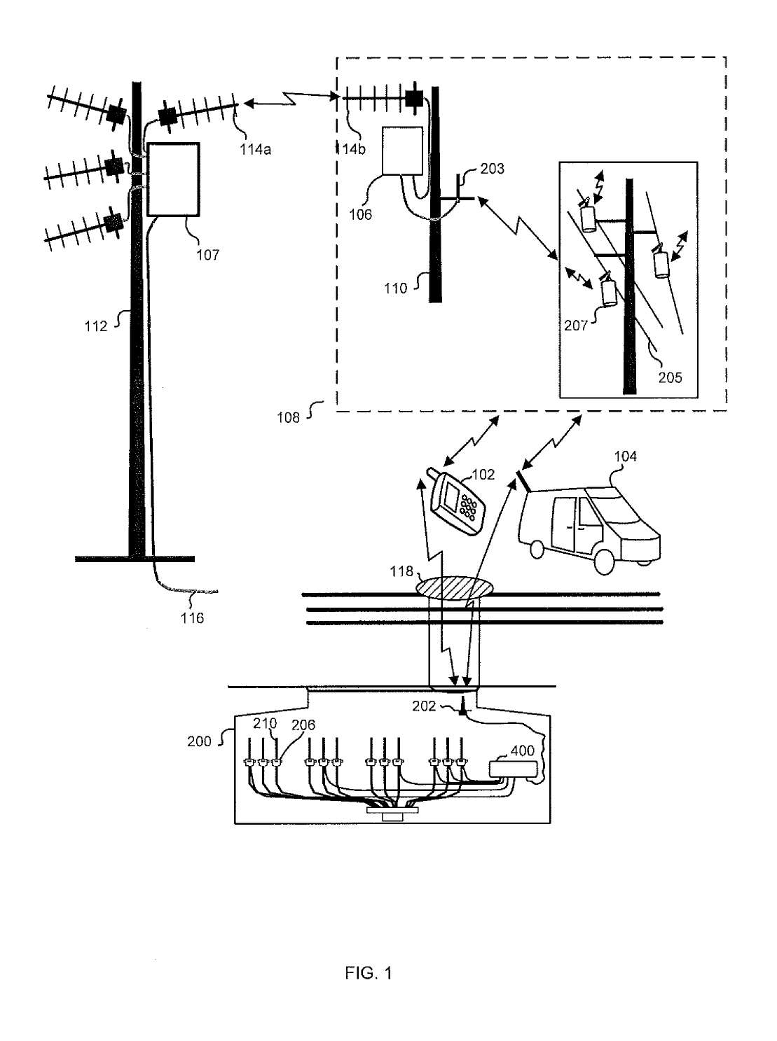

FIG. 1 illustrates a faulted circuit indicator monitoring system in accordance to the present invention A number of overhead faulted circuit indicators 207 each contain a two-way radio that communicates the occurrence of a fault via a short range antenna 203 to a local site 110 having an intelligent module 106 installed near the faulted circuit indicators 207. The intelligent module then uses the existing wired telephone network (not shown) or a long range RF antenna 114b to communicate the fault occurrence to a remote site 112 via another long range RF antenna 114a. The remote site 112 includes a remote module 107, which is connected to another site (not shown) via a wired connection 116. When a fault is detected by a faulted circuit indicator, the occurrence is relayed in the manner described above to the remote site 112, triggering the dispatch of a team to the fault site. The fault team then uses a wireless device 102 (e.g., a wireless handheld device) or a wireless device installed in a vehicle 104 to determine precisely which conductor 205 is faulted. Note that the conductors could also be underground 200 and only accessible through an access port (e.g. a manhole) 118. Faulted circuit indicators 206 attached to the underground conductors are wired to a radio interface unit 400 with a separate short range antenna 202 to communicate with the wireless device 102 or wireless device installed in a vehicle 104.

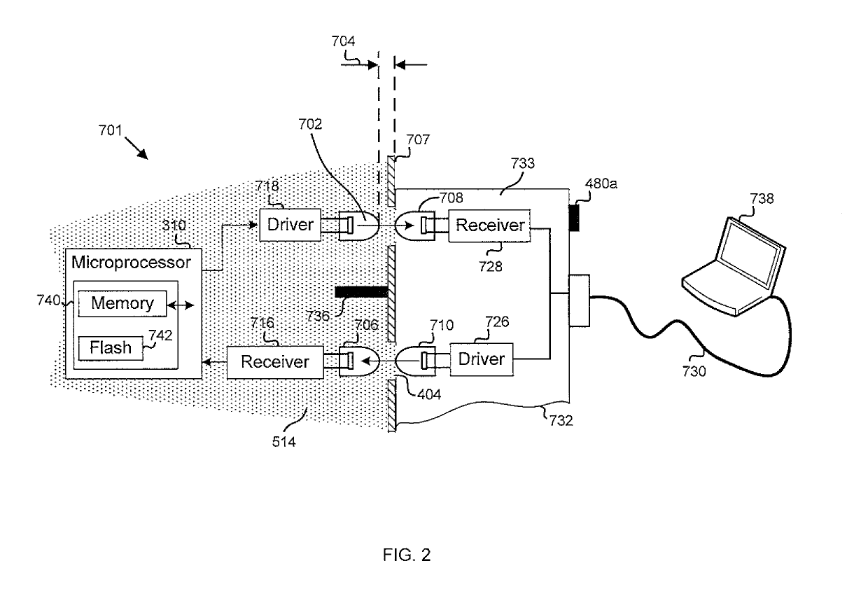

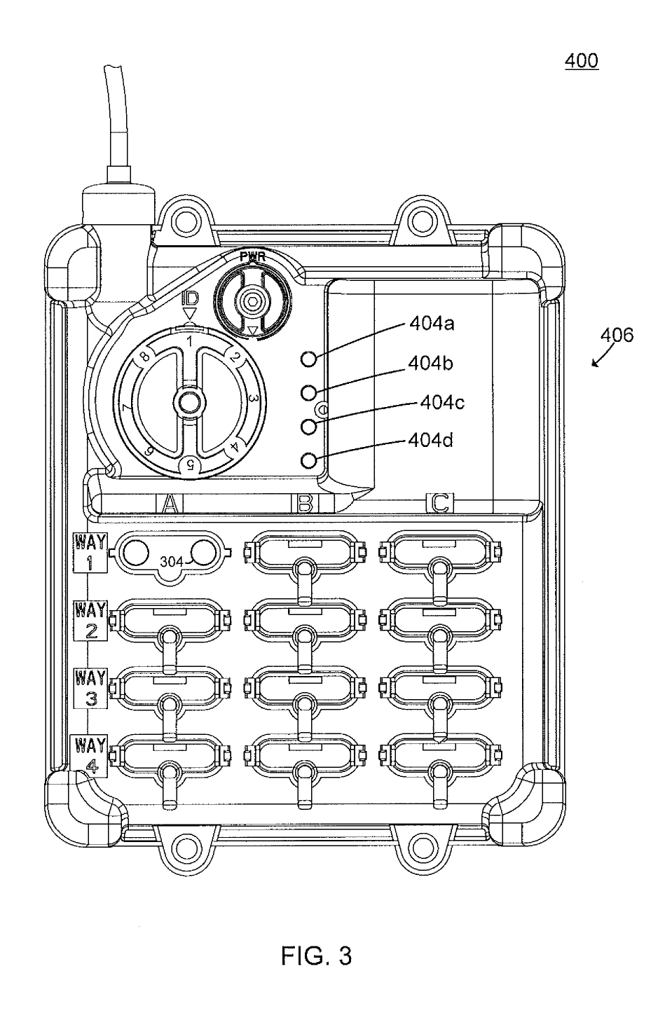

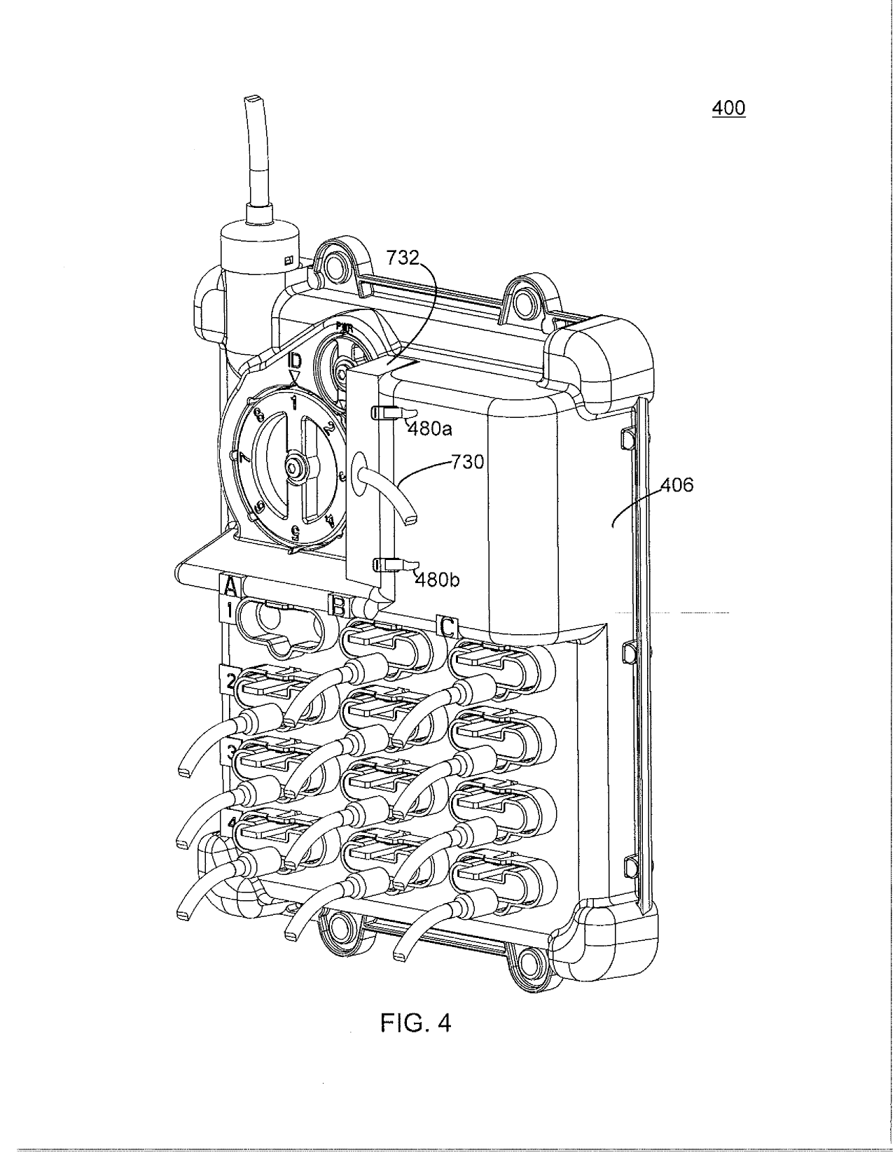

Referring to the drawings, and to FIG. 2 in particular, an optical communication device 732 is connected to an electronic device 701. For example, in one embodiment, as will be described with respect to FIGS. 3 and 4 below, the electronic device may be in the form of a radio interface unit. The electronic device 701 may be hardened. The electronic device 701 may be a power system protection, control, or monitoring system such as a faulted circuit monitoring system. The electronic device 701 may include a radio for transmission of data. The illustrated electronic device 701 includes a radio interface unit 400.

Referring back to FIG. 2, the optical communication device 732 is depicted as connected to an electronic data source. For illustration purposes only, the embodiment shown in this figure depicts a notebook computer 738 connected to the optical communication device 732 via an interface cable 730 using a wired protocol, such as Universal Serial Bus (USB) or RS232 interface. However, other embodiments could utilize a short range wireless connection between the optical communication device 732 and the notebook computer 738, a long range wireless connection between the optical communication device 732 and a server located at a remote site (not shown), or some other mechanism for supplying data to the optical communication device. In addition, the optical communication device 732 may contain the data to be communicated to the electronic device 701.

The electronic device 701 contains a circuit board (not shown) with at least one phototransmitter 702 as well as at least one photodetector 706. The phototransmitter 702 is disposed within the housing 707 of the electronic device 701 so that the axial line of the lens of the phototransmitter 702 is centered within an aperture 404 of the housing 707. The phototransmitter is electrically coupled to a driver circuit 718, which translates data from the microprocessor 310 into electrical pulses suitable for transmission by the phototransmitter 702. Depending on the type of driver circuit used as well as the microprocessor and the phototransmitter, additional interface circuitry may be required, such as the interface circuit depicted in FIG. 2. In the illustrated embodiment, the lens of the phototransmitter 702 is completely covered by a width 704 of semi-opaque material, which may be a potting material 514. Preferably, the electronic components are environmentally sealed within the potting material 514. A semi-opaque material is one that is partially transmissive to a particular wavelength of radiation. The potting material may be, but is not limited to, an epoxy based material, a urethane based material, a silicone based material, an acrylic based material, or a polyester based material.

The electronic device 701 also contains at least one photodetector 706. The photodetector 706 is disposed within the electronic device 701 so that the axial line of the lens of the photodetector 702 is centered within the aperture 404. The photodetector 706 is electrically coupled to a receiver circuit, such as a UART, which is capable of transforming the electrical output of the photodetector 706 into a form understandable by the microprocessor 310. Depending on the type of receiver circuit 716 used, as well as the microprocessor and the photodetector, additional interface circuitry may be required. In the illustrated embodiment, the lens of the photodetector 706 is completely covered by a width 704 of semi-opaque material, which may be potting material 514.

The microprocessor 310 within the electronic device 701 may require some amount of random access memory 740 and some amount of persistent storage, such as FLASH memory 742. Note that the memory 740 and persistent storage may reside within the microprocessor 310 or may be separate from it (not illustrated). In addition, different types of processing devices, such as microcontrollers or digital signal processors, may be used. Microprocessor is meant to be interpreted within this document as any data processing component. Some further examples of processing devices may include field programmable gate arrays (FPGAs), programmable logic devices, complex programmable logic devices (CPLDs) and the like.

Note that the system described above includes the use of housings 707, 733 for both the electrical device 701 and the optical communications device 732. However, a housing 707 is not required for either device to practice this invention. For instance, a collection of circuits comprising an electronic device including a photodetector could be encapsulated within potting material. A second collection of circuits comprising an optical communications device including a phototransmitter could be encapsulated within potting material. The two devices could then be positioned so that the lens of the phototransmitter and the lens of the photodetector were axially aligned.

As illustrated, the optical communication device 732 contains at least one photodetector 708 disposed within a housing 733. The photodetector 708 is situated within the housing 733 so that its lens is near or touching the interior wall of the housing 733, which is constructed of a material that transmits the radiation the photodetector 708 is attuned to with minimal distortion. In addition, the photodetector 708 is electrically coupled to a receiver circuit 728 which transforms electrical pulses from the photodetector into data which is forwarded to the notebook computer 738 via the cable 730. Similarly, the optical communication device 732 contains at least one phototransmitter 710 disposed within the housing 733 so that its lens is near or touching the interior wall of the housing 733. The phototransmitter 710 is electrically coupled to a driver circuit 726, which transforms data from the notebook computer 738 into electrical pulses suitable for transmission by the phototransmitter 710.

As illustrated, in one embodiment the electronic device includes a housing 707. The housing 707 may include an extension 736 that extends between the phototransmitter 702 and photodetector 706. This extension 736 may be opaque in that it does not allow for significant transmission of radiation between the phototransmitter 702 and photodetector 706. This extension 736 may be used to block stray radiation between the phototransmitter 702 and photodetector 706. Further, in an embodiment where there are several photodetectors 706 within the potting material, the extension 736 between each of the several photodetectors 706 would limit or eliminate cross-radiation from phototransmitters 710 of the optical communication device 732.

During operation a user will position the optical communication device 732 relative to the electronic device 701 such that the photodetector 706 and phototransmitter 702 of the electronic device 701 optically align with the photodetector 708 and the phototransmitter 710 of the optical communication device 732. Using software on the notebook computer 738, the user will initiate communication with the electronic device 701. Data is transmitted from the notebook computer 738 to the optical communication device 732 using the interface cable 730. The driver circuit 726 of the optical communication device transforms data from the notebook computer 738 into electrical pulses which are then transformed into optical pulses by the phototransmitter 710.

As indicated, data may flow in one direction, or in both directions, and this data could be related to the protocol, i.e., error checking packets; or it could be substantive. The data that is transmitted could be a firmware update of the electronic device 701. It could also be settings or configuration information, or some other kind of information. Further, the data may include a control or a command.

The optical pulses transmitted by the phototransmitter 710 of the optical communication device 732 are detected by the photodetector 706 of the electronic device 701. The photodetector 706 transforms the received optical pulses into electrical pulses which are captured by the receiver circuit 716. The receiver circuit 716 transforms the electrical pulses into a form understandable by the microprocessor 720, and passes the resultant data on. The receiver circuit's 716 transformation may take the form of generating serial data in a particular format understood by the microprocessor 310, such as I2C, or it may take the form of generating parallel byte or word length data in a format usable by the microprocessor 310. Once information is received the microprocessor may then store the information in persistent storage 742.

Also, data may be transmitted from the electronic device 701 to the optical communication device 732 in a similar manner as described above. The driver circuit 718 of the intelligent electronic device 701 transforms data from the microprocessor 310 into electrical pulses which are then transformed into optical pulses by the phototransmitter 702. The optical pulses transmitted by the phototransmitter 702 of the electronic device 701 are detected by the photodetector 708 of the optical communication device 732. The photodetector 708 transforms the received optical pulses into electrical pulses which are captured by the receiver circuit 728. The receiver circuit 728 transforms the electrical pulses into a form understandable by the notebook computer 738, and passes the resultant data on.

In one embodiment of the present invention, the electronic device of the previous embodiments may be in the form of a radio interface unit 400 as shown in FIG. 3. This radio interface unit 400 may further communicate with a faulted circuit indicator or other protective device or monitoring device for use in an electrical power system. The radio interface unit 400 may include apertures 404a-404d where photodetectors or phototransmitters are positioned in the housing 406. As discussed above, corresponding photodetectors and phototransmitters of an optical communication device may be positioned in relation to these apertures 404a-404d in order to commence transmission of data therebetween and through the semi-opaque material contained within the housing 406. For example, as illustrated in FIG. 4, an optical communication device 732 is shown to be positioned in relation to the housing 406 of the radio interface unit 400 such that it aligns with the apertures in the previous figure. Additionally, latching mechanisms 480a and 480b are shown which provide proper positioning and securing of the optical communication device 732 to the radio interface unit 400.

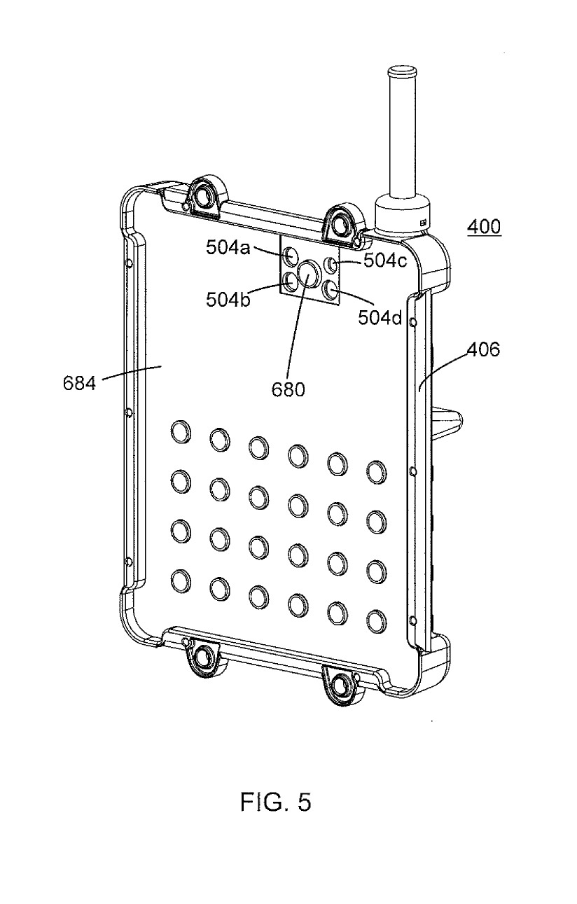

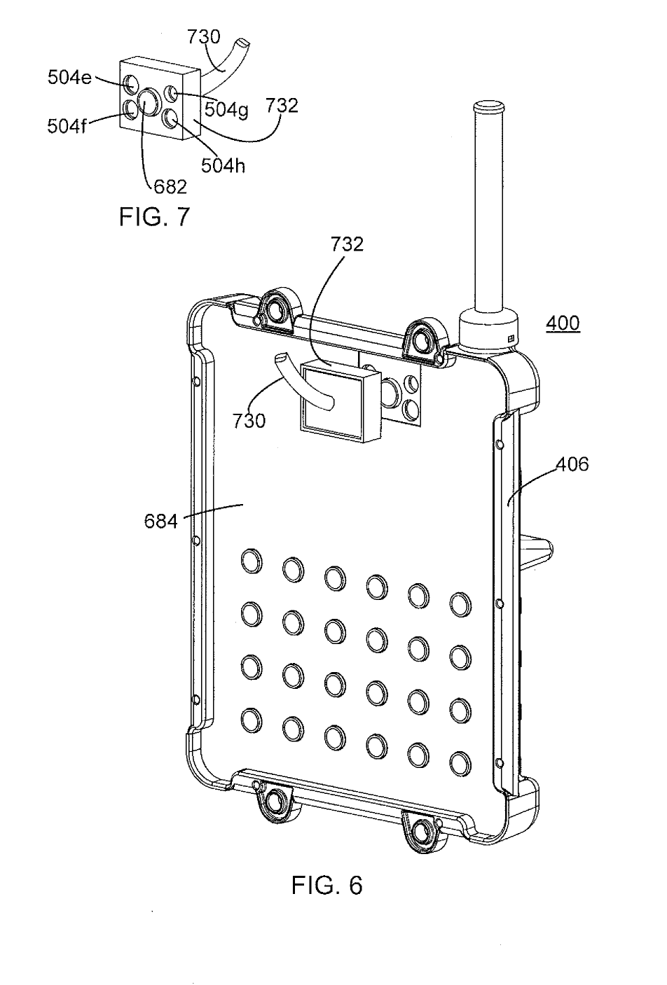

In another embodiment of the present invention, the electronic device of the previous embodiments may be in the form of a radio interface unit 400 as shown in FIG. 5. This radio interface unit 400 may further communicate with a faulted circuit indicator or other protective device or monitoring device for use in an electrical power system. The radio interface unit 400 may include apertures 504a-504d where photodetectors or phototransmitters are positioned in the housing 506. According to this embodiment, the apertures 504a-504d are formed in the potting material 684. As discussed above, corresponding photodetectors and phototransmitters 504e-504h (of FIG. 7) of an optical communication device 732 may be positioned in relation to these apertures 504a-504d in order to commence transmission of data therebetween and through the semi-opaque material contained within the housing 406. For example, as illustrated in FIGS. 6 and 7, an optical communication device 732 is shown to be positioned in relation to the housing 406 of the radio interface unit 400 such that it aligns with the apertures in the previous figure. Additionally, an alignment and/or securing mechanism 680, 682 is shown which provides proper positioning and/or securing of the optical communication device 732 to the radio interface unit 400. The alignment and/or securing mechanism 680, 682 illustrated is a pressure-fit aperture 680 wherein the optical communication device 732 includes an extended portion 682 that is approximately the same size as, and fits firmly into the pressure-fit aperture 680, aligning the apertures and holding the optical communication device 732 in place.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

1. An optical communication system comprising:
i) a phototransmitter for generating an optical signal, and
ii) a photodetector encapsulated within a semi-opaque material so that the photodetector is optically coupled through the semi-opaque material to the phototransmitter so that the photodetector can receive the optical signal and generate an electrical signal representative of the optical signal.

2. The system of claim 1 wherein the semi-opaque material is a potting material.

3. The system of claim 2, wherein the potting material is selected from the group consisting of an epoxy based material, an urethane based material, a silicone based material, an acrylic based material, and a polyester based material.

4. The system of claim 1 wherein the phototransmitter generates infrared radiation, and wherein the photodetector is an infrared photodetector.

5. The system of claim 1 wherein the phototransmitter generates light in the visible spectrum at a predetermined wavelength, and wherein the photodetector receives light in the visible spectrum at the predetermined wavelength.

6. The system of claim 1 wherein the photodetector is coupled to a power system device.

7. The system of claim 6 wherein the protective device is a faulted circuit indicator.

8. The system of claim 1 wherein the photodetector is coupled to a faulted circuit monitoring system.

9. The system of claim 1, wherein the photodetector is coupled to a wireless radio.

10. The system of claim 9, wherein the wireless radio is coupled to a power system device.

11. The system of claim 10, wherein the power system device is a faulted circuit monitoring system.

12. The system of claim 1, wherein the photodetector is generally aligned with the phototransmitter.

13. An apparatus for transmitting information to a power system device having an optical interface, the apparatus comprising:
i) a circuit board;
ii) a phototransmitter having a lens disposed on the circuit board; and
iii) potting material disposed over the circuit board so that the circuit board is substantially covered and so that the lens of the phototransmitter is covered by the potting material.

14. The apparatus of claim 13 further comprising a housing with an aperture and wherein the circuit board is disposed within the housing and wherein the lens of the phototransmitter is axially aligned with the aperture.

15. The apparatus of claim 14 further comprising a latching mechanism coupled to the housing and adapted to couple an optical communication device to the housing.

16. The apparatus of claim 13 further comprising an alignment mechanism formed into the potting material and adapted to couple an optical communication device to the potting material.

16. The apparatus of claim 13 wherein the phototransmitter generates infrared radiation.

17. The apparatus of claim 13, wherein the potting material is selected from the group consisting of an epoxy based material, an urethane based material, a silicone based material, an acrylic based material, and a polyester based material.

18. The apparatus of claim 13, further comprising:
i) a photodetector having a lens disposed on the circuit board; and
ii) the potting material further disposed so that the lens of the photodetector is covered by the potting material.

19. The apparatus of claim 14, further comprising a housing with an aperture and wherein the circuit board is disposed within the housing and wherein the lens of the phototransmitter is axially aligned with the aperture.

20. The apparatus of claim 18, wherein the photodetector and the phototransmitter are not in optical communication.

21. The apparatus of claim 18, wherein the housing includes an opaque extension that extends between the photodetector and the phototransmitter

22. A power system device having an optical interface comprising:
i) a circuit board;
ii) a photodetector having a lens disposed on the circuit board; and
iii) potting material disposed over the circuit board so that the circuit board is substantially covered, the potting material further disposed so that the lens of the photodetector is covered by the potting material.

23. The power system device of claim 22 further comprising a housing with an aperture and wherein the circuit board is disposed within the housing and wherein the lens of the photodetector is axially aligned with the aperture.

24. The power system device of claim 23 further comprising a latching mechanism coupled to the housing, the latching mechanism adapted to couple an optical communication device to the housing.

25. The power system device of claim 22 wherein the photodetector is adapted to detect infrared radiation.

26. The power system device of claim 22, wherein the potting material is selected from the group consisting of an epoxy based material, an urethane based material, a silicone based material, an acrylic based material, and a polyester based material.
